(19) United States
(12) Patent Application Publication
(10) Pub. No.: US 2024/0073194 A1
(43) Pub. Date: Feb. 29, 2024

(54) SYSTEMS AND METHODS FOR PROVIDING A DIGITAL CREDENTIALS REGISTRY

(71) Applicant: ATB FINANCIAL, Edmonton (CA)

(72) Inventors: Nav DHUNAY, Calgary (CA); Julie KERR, Calgary (CA)

(21) Appl. No.: 18/259,938

(22) PCT Filed: Dec. 29, 2021
(86) PCT No.: PCT/CA2021/051897

§ 371 Date: Jun. 29, 2023

Related U.S. Application Data
(60) Provisional application No. 63/131,988, filed on Dec. 30, 2020.

(51) Int. Cl. H04L 9/40

(52) U.S. Cl. CPC H04L 63/08; H04L 9/50

(57) ABSTRACT

Systems, devices, and methods for providing and operating a digital credentials registry. A digital credentials registry may facilitate ecosystems of self-sovereign identity by allowing issuers to create digital credentials (e.g., based on existing schemas), and allowing participants to find relevant issuers and/or verifiers.

### CROSS-REFERENCE TO RELATED APPLICATIONS

This application claims all benefit, including priority of U.S. Provisional Patent Application No. 63/131,988, filed Dec. 30, 2020, the entire contents of which are incorporated herein by reference.

### FIELD

This disclosure relates to digital credentials, and more particularly relates to a registry for digital credentials.

### BACKGROUND

In the physical world, physical credentials can be used to prove an identity. For example, whenever an individual boards an airplane or applies for a credit card, that individual may be requested to prove an assertion about themselves (e.g., an aspect of their identity) by presenting one or more credential documents issued by a trusted authority (e.g., an credential issuer) to someone who needs to trust the assertion (e.g., a credential verifier). Such credentials documents may include, for example, a passport, a driver's license, or the like, and provide proof of the individual's assertion. In the digital online world, there is a need for improved ways to issue, use, and verify digital credentials.

### SUMMARY

In accordance with an aspect, there is provided a computer-implemented method for providing a digital credentials registry. The method includes receiving, from an issuer device, a request to search an electronic data store storing data records reflective of a plurality of schemas for defining credential definitions, the request including at least one search criterion; transmitting a response to the issuer device reflecting at least one matched schema of the plurality of schemas, the matched schema satisfying the at least one search criterion; and receiving, from the issuer device, data reflective of a credential definition based on at least one of the matched schema, the credential definition including a plurality of claims available to be made by the issuer about another entity.

In accordance with another aspect, there is provided a computer-implemented system for providing a digital credentials registry. The system includes: at least one processor; memory in communication with the at least one processor, and software code stored in the memory. The software code when executed by the at least one processor causes the system to: receive, from an issuer device, a request to search an electronic data store storing data record reflective of a plurality of schemas for defining credential definitions, the request including at least one search criterion; transmit a response to the issuer device reflecting at least one matched schema of the plurality of schemas, the matched schema satisfying the at least one search criterion; and receive, from the issuer device, data reflective of a credential definition based on at least one of the matched schema, the credential definition including a plurality of claims available to be made by the issuer about another entity.

In accordance with another aspect, there is provided a computer-implemented method for providing a digital credentials registry. The method includes: receiving, from a verifier device, a proof request, the proof request including at least one attribute about an entity; searching within an electronic data store storing data records of a plurality of credential definitions to identifying those matching credential definitions that include a claim that matches an attribute of the proof request; and transmitting a response to the verifier device that includes a list of the matching credential definitions.

In accordance with another aspect, there is provided a computer-implemented system for providing a digital credentials registry. The system includes: at least one processor; memory in communication with the at least one processor, and software code stored in the memory. The software code when executed by the at least one processor causes the system to: receive, from a verifier device, a proof request, the proof request including at least one attribute about an entity; search within an electronic data store storing data records of a plurality of credential definitions to identifying those matching credential definitions that include a claim that matches an attribute of the proof request; and transmit a response to the verifier device that includes a list of the matching credential definitions.

In accordance with another aspect, there is provided a computer-implemented method for providing a digital credentials registry. The method includes: receiving, from an end-user device, a request to search within an electronic data store storing data record reflective of a plurality of credential definitions, the request including at least one search criterion; searching within an electronic data store storing data records of a plurality of credential definitions to identifying those matching credential definitions that satisfy the at least one search criterion; and transmitting a response to the end-user device that includes a list of the matching credential definitions.

In accordance with another aspect, there is provided a computer-implemented system for providing a digital credentials registry. The system includes: at least one processor; memory in communication with the at least one processor, and software code stored in the memory. The software code when executed by the at least one processor causes the system to: receive, from an end-user device, a request to search within an electronic data store storing data record reflective of a plurality of credential definitions, the request including at least one search criterion; search within an electronic data store storing data records of a plurality of credential definitions to identifying those matching credential definitions that satisfy the at least one search criterion; and transmit a response to the end-user device that includes a list of the matching credential definitions.

Many further features and combinations thereof concerning embodiments described herein will appear to those skilled in the art following a reading of the instant disclosure.

### BRIEF DESCRIPTION OF THE DRAWINGS

In the figures,

FIG. 1 is a network diagram of a network environment for a digital credentials registry system, in accordance with an embodiment;

FIG. 2 is high-level schematic diagram of example operation of an ecosystem of decentralized digital credentials in which the digital credentials registry system of FIG. 1 may operate, in accordance with an embodiment;

FIG. 3 is a high-level schematic diagram of a registry server of the digital credentials registry system of FIG. 1, in accordance with an embodiment;

FIG. 4 is an example table of data relating to digital credentials which may be stored at the registry server of FIG. 3, in accordance with an embodiment;

FIG. 5A is a code listing of an example entity model for data stored at the registry server of FIG. 3, in accordance with an embodiment;

FIG. 5B is a graphical representation of the entity model of FIG. 5A, in accordance with an embodiment;

FIG. 6 is a code listing of an example schema that may be stored at registry server of FIG. 3, in accordance with an embodiment;

FIG. 7 is a high-level schematic diagram of a schema server of the digital credentials registry system of FIG. 1, in accordance with an embodiment;

FIG. 8 is a code listing of an example proof request that may be received at the registry server of FIG. 3, in accordance with an embodiment;

FIG. 9, FIG. 10, and FIG. 11 each is an example screen of a wallet application, in accordance with an embodiment; and

FIG. 12 is a schematic diagram of a computing device, in accordance with an embodiment.

These drawings depict exemplary embodiments for illustrative purposes, and variations, alternative configurations, alternative components and modifications may be made to these exemplary embodiments.

### DETAILED DESCRIPTION

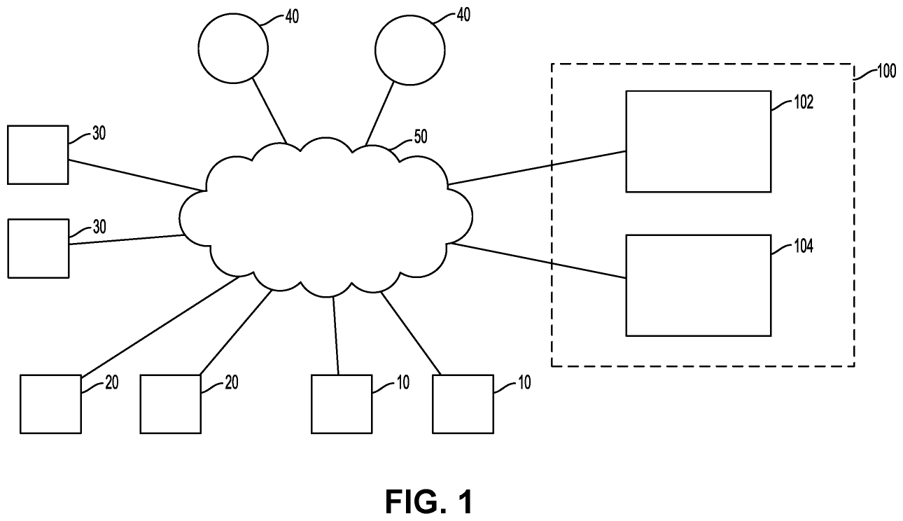

FIG. 1 is a network diagram showing a network environment of a digital credentials registry system 100, in accordance with an embodiment. Digital credentials registry system 100 provides searchable electronic repositories of data relating to digital credentials and electronic interfaces for accessing, manipulating, and using such data by participants in one or more ecosystems of decentralized digital credentials.

In FIG. 1, the depicted network environment includes credential registry system 100 interconnected, by way of a network 50, with a plurality of issuer devices 10, a plurality of end-user devices 20, a plurality of verifier devices 30, and a plurality of blockchain devices 40.

In the depicted embodiment, credentials registry system 100 includes a registry server 102 and a schema server 104. In some embodiments, one or both of registry server 102 and schema server 104 may be implemented as a cloud-based server. Although registry server 102 and schema server 104 are shown to be separate in FIG. 1, in some embodiments, some or all of the functionality of registry server 102 and schema server 104 may be provided in a single server.

Registry server 102 collects and maintains data relating to digital credentials such as, for example, a list of digital credentials and their constituent claims, entities issuing those digital credentials (each referred to herein as an “issuer”), entities that desire to place trust in claims contained in a digital credential, and therefore need to verify those claims (each referred to herein as a “verifier”), or the like. Registry server 102 also provides electronic interfaces that allow such data to be searched, retrieved, submitted, or modified in manners disclosed herein. As used herein, digital credentials may refer to a definition of credentials usable within a decentralized digital credentials ecosystem, rather than instances of credentials issued for a particular entity.

Schema server 104 allows issuers to define digital credentials, e.g., based on schemas provided at server 104. Schema server 104 also allows verifiers to indicate which digital credentials (or particular claims thereof) they will accept, e.g., which may be based on the trustworthiness of those credentials or claims.

An issuer device 10, under control of a given issuer, interoperates with digital credentials registry system 100 in manners disclosed herein, e.g., to create a new credential definition that defines a digital credential issued by the given issuer. Although FIG. 1 shows two issuer devices 10, credentials registry system 100 may interoperate with any number of issuer devices 10 under control of any number of issuers.

An end-user device 20, under control of a given end-user, interoperates with credential registry system 100 in manners disclosed herein, e.g., to search data stored at credential registry system 100 for data regarding particular digital credentials, issuers, verifiers, or the like, and to retrieve at least portions of such data. In some embodiments, such search and retrieval functionality may be implemented as part of a digital credentials wallet application executing at end-user device 20 of a given end-user. Such a digital credentials wallet application may store instances of digital credentials issued by an issuer to the given end-user.

A verifier device 30, under control of a given verifier, interoperates with digital credentials registry system 100 in manners disclosed herein, e.g., to obtain data therefrom regarding issued digital credentials (and their claims), and to provide indications of which digital credentials (or particular claims) are accepted by the given verifier. Although FIG. 1 shows two verifier devices 30, digital credentials registry system 100 may interoperate with any number of verifier devices 30 under control of any number of verifiers.

Blockchain devices 40 are devices that function as nodes of a blockchain or other type of distributed ledger on which verification data are stored. Such verification data may include, for example, signed credentials or claims, public keys for issuers, or the like. In some embodiments, a blockchain device 40 may function as a node of a public network such as the Sovrin network, the Uport network, the Bedrock network, the Ethereum network, the Bitcoin network, or the like. In some embodiments, a blockchain device 40 may function as node of a private blockchain network.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPv4, IPv6, X.25, IPX or similar network. Portions of network 50 could be, for example, a GSM, GPRS, 3G, LTE or similar wireless networks. Network 50 may include or be connected to the Internet. When network 50 is a public network such as the public Internet, it may be secured as a virtual private network.

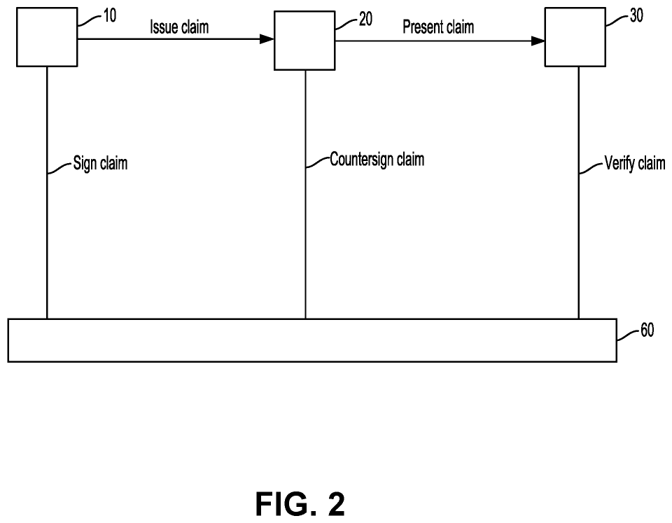

FIG. 2 schematically depicts example operation of an example ecosystem of decentralized digital credentials in which digital credentials registry system 100 may operate. In this ecosystem, there is a blockchain 60, which may be provided by a network of blockchain devices 40. Such a network may, for example, be the Sovrin network. However, as explained herein, digital credentials registry system 100 may interoperate with various other networks.

Blockchain 60 may store a plurality of decentralized identifiers, each associated with a public-private key pair of an entity (e.g., an issuer or an end-user). Such decentralized identifiers may conform, for example, with the Decentralized Identifiers (DIDs) standard established by the World Wide Web Consortium. DIDs are globally unique identifiers that do not require a registration authority and facilitate ecosystems of self-sovereign identity. In some embodiments, digital credentials registry system 100 facilitates ecosystems of self-sovereign identity by allowing issuers to create digital credentials (e.g., based on existing schemas), allowing verifiers to find relevant issuers and digital credentials, and allowing users to find relevant issuers and/or verifiers.

As will be appreciated by a person skilled in the art, a digital signature can require two keys to operate. First, a private or signing key is used to sign a document (e.g., a claim), and is kept secret. Second, a public or verification key is used to verify the signature and ensure the document has not been tampered with. Blockchain 60 may store each DID in association with a public key of the entity registered to that DID. Verifiers can verify a signed document by retrieving the issuer's public key from blockchain 60 using the issuer's DID.

As shown in FIG. 2, an issuer at issuer device 10 can issue a claim (relating to an aspect of an end-user) by signing the claim using the private key associated with the issuer's DID. The issued claim is provided to the end-user at end-user device 20. Optionally, the end-user can counter-sign the issued claim using the private key associated with his/her DID. Issued claims may, for example, be stored in an electronic wallet application executing at the end-user device 20. This claim is then presented to a verifier device 30. Verifier device 30 can retrieve the public key of the issuer from blockchain 60 to verify the issuer's signature for the claim. Optionally, verifier device 30 can retrieve the public key of the end-user from blockchain 60 to verify the end-user's signature for the claim.

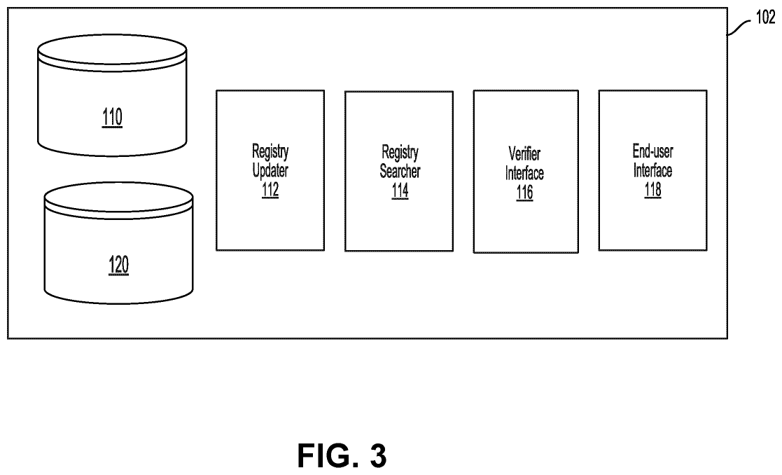

FIG. 3 is a high-level schematic of registry server 102, in accordance with an embodiment. As depicted, registry server 102 includes an electronic data store 110, an electronic data store 120, and a registry updater 112, a registry searcher 114, a verifier interface 116, and an end-user interface 118.

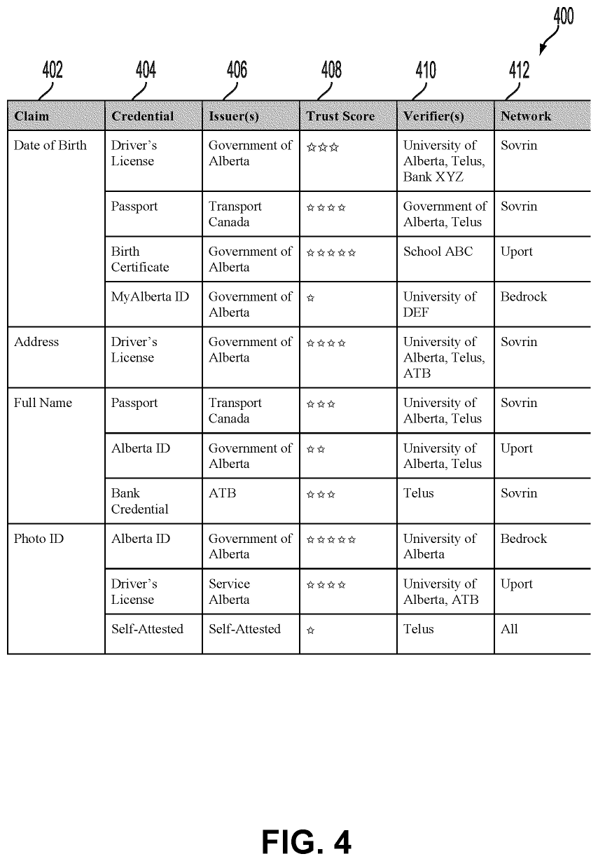

Electronic data store 110 stores one or more data structures that contain data relating to digital credentials, including e.g., published credential definitions. FIG. 4 shows example data that may be stored in such data structures, in accordance with an embodiment.

FIG. 4 shows a data table 400 organized in a plurality of rows and columns.

Column 402 includes data reflecting a plurality of claims, where each claim is an assertion about an attribute of a subject individual that is relevant to that individual's identity. Examples of a claim include, for example, date of birth, height, government ID number, postal address, or the like. In some cases, a claim may be an assertion about an attribute of an individual other than the subject individual.

Column 404 includes data reflecting a plurality of credentials, where each credential contains one or more claims of column 402. Credentials having claims that can be verified, e.g., signed by an issuer, may be referred to as a “verifiable credential.” In some embodiments, electronic data store 110 may include data identifying one or more schemas in association with each digital credential, which are used to define that digital credential. As used herein, a schema is a machine-readable definition of the semantics of a data structure, and may be used to define the sematic structure of credential (e.g., its constituent claims).

Column 406 includes data reflecting the issuers of the digital credentials of column 404.

Column 408 includes data reflecting trust scores, each of which reflects a degree of trustworthiness of a claim of column 402 that is part of a particular digital credential issued by a particular issuer. Of note, different trust scores may be associated with the same claim, when such claims are part of different digital credentials, even when issued by the same issuer. For example, in the data of table 400, a “date of birth” claim on a “Birth Certificate” issued by the Government of Alberta has a trust score of 5, while a “date of birth” claim on a “Driver's License” credential also issued by the Government of Alberta has a different trust score, namely, a trust score of 3. Also, different trust scores may be associated with different claims of the same digital credential. For example, in the data of table 400, a “date of birth” claim on a “Driver's License” credential issued by the Government of Alberta has a trust score of 3, while an “address” claim on the same “Driver's License” credential has a different trust score, namely, 4.

In some embodiments, trust scores may be automatically calculated at registry server 102. For example, trust scores may be calculated based on reviews or endorsements from ecosystem participants, e.g., whether particular verifiers, end-users, or issuers trust a particular issuer or a particular claim.

Column 410 includes data reflecting one or more verifiers that will accept the claim in column 402.

Column 412 includes data reflecting an identifier of one or more networks from which verification data for the claim in column 402 may be retrieved.

Although the data in FIG. 4 is shown in tabular format, this data may be organized in various ways in electronic data store 10, e.g., in multiple tables or various data structures.

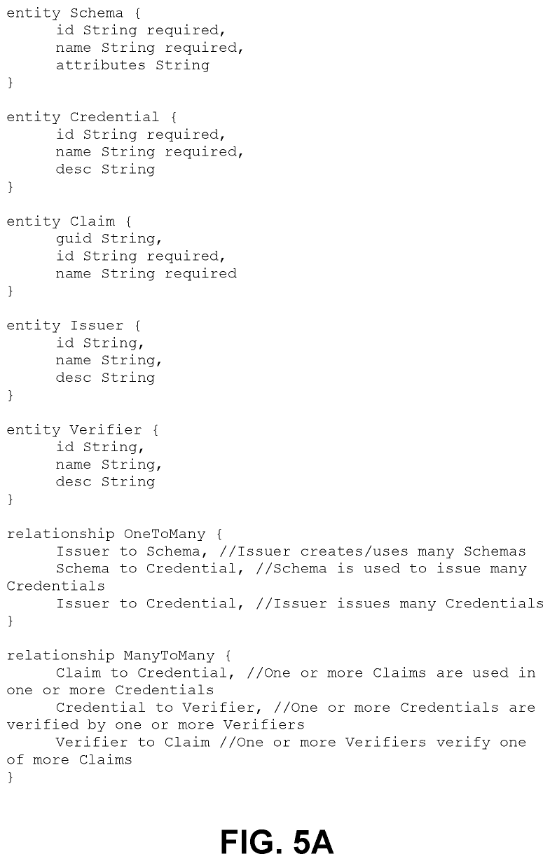

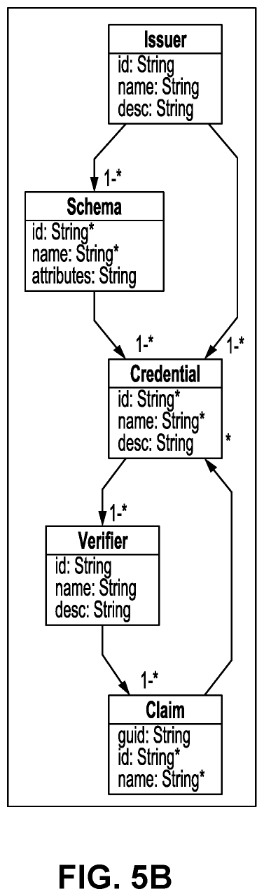

FIG. 5A is an example code listing of an entity model in JDL format for certain entities in the data of electronic data store 110, and FIG. 5B is a graphical representation of this entity model, in accordance with an embodiment. This entity model includes entities representing schemas, credentials, claims, issuers, and verifiers, and the relationships therebetween (e.g., one-to-many or many-to-many).

Electronic data store 120 stores one or more data structures containing schemas for defining credentials. Each schema includes a machine-readable definition of the semantics of a data structure, and in particular the structure of at least a portion of a digital credential.

In some cases, a schema may refer to one or more other schemas, allowing credentials to be defined with references to multiple schemas. Such schemas may be referenced in a hierarchical manner. The one or more schemas that define a credential may be referred to as a credential definition.

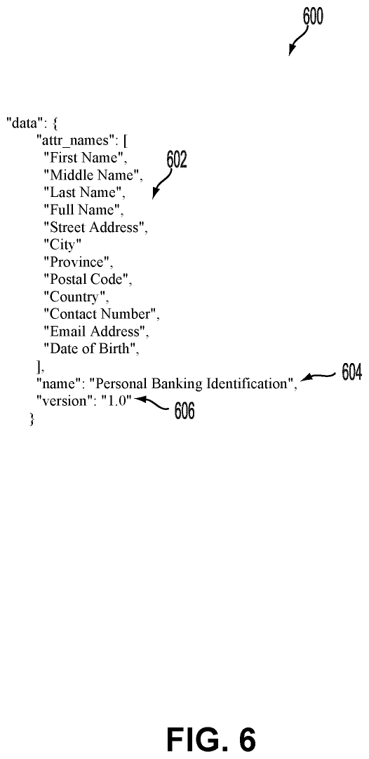

FIG. 6 is an example JSON code listing for an example schema 600. As shown, schema 600 includes indicators of a plurality of attributes 602, which correspond to claims in a digital credential defined using schema 600. Schema 600 also includes a name 604 of the schema and a version identifier 606.

Referring again to FIG. 3, registry updater 112 updates the data stored in electronic data store 110, e.g., based on data received from schema server 104. In one example, registry updater 112 may update columns 402, 404, 406, and 412 of table 400 based on a request to publish a credential definition, received from schema server 104. In another example, registry updater 112 may update column 410 based on indicators of particular verifiers that accept particular claims, as received from schema server 104. Registry updater 112 may also update column 408, e.g., in response to trust scores inputted by an administrator or automatically computed at registry server 102.

Registry updater 112 also updates data stored in electronic data store 120, e.g., based on data received from schema server 104. For example, registry updater 112 may update electronic data store 120 to include schemas provided by schema server 104 for publication.

Registry updater 112 may include suitable interfaces for querying the database(s) of electronic data store 110 or electronic data store 120, e.g., to write data to such databases.

Registry searcher 114 conducts searches of the data stored in electronic data store 110 and/or electronic data store 120. In one example, such searches may be conducted in response to requests received from a verifier by way of verification interface 116. In another example, such searches may be conducted in response to requests received from an end-user by way of end-user interface 118. Registry searcher 114 includes suitable interfaces for querying the database(s) of electronic data store 110, e.g., to receive data from such databases.

Verifier interface 116 provides an electronic interface for communication between registry server 102 and verifier devices 30. In some embodiments, the electronic interface may be a REST interface exposing an API for access by software executing at a verifier device 30.

Verifier interface 116 may receive a signal from a verifier device 30 reflecting a request for credentials containing claims corresponding to attributes of a subject individual that a verifier wishes to confirm. Such requests may be referred to as a “proof request.” Verifier interface 116 may transmit a signal to a verifier device 30 reflecting a list of credentials responsive to the proof request.

End-user interface 118 provides an electronic interface for communication between registry server 102 and end-user devices 20. In some embodiments, the electronic interface may be a REST interface exposing an API for access by software executing at an end-user device 20, e.g., a digital credentials wallet application.

End-user interface 118 may receive a signal from an end-user device 20 reflecting a request to receive a list of issuers that meet one or more search criteria, e.g., issuers matching a desired name or search string, issuers within a certain geography or legal jurisdiction, issuers who issue credentials having a desired claim, issuers who issue credentials having a claim with a trust score above a pre-defined threshold, issuers who issue credentials having a claim that is accepted by a particular verifier, or the like. End-user interface 118 may transmit a signal to an end-user device 20 with data encoding a list of issuers responsive to the request. End-user interface 118 may receive a signal from an end-user device 20 reflecting a request to receive a list of verifiers that meet one or more search criteria, e.g., verifiers matching a desired name or search string, verifiers within a certain geography or legal jurisdiction, verifiers offering desired products or services, verifiers accepting particular verifiable credentials held by the end-user, or the like. End-user interface 118 may transmit a signal to an end-user device 20 with data encoding a list of verifiers responsive to the request.

Electronic data stores 110 and 120 may each implement a conventional relational, object-oriented, NoSQL database, such as Microsoft SQL Server, Oracle, DB2, Sybase, Pervasive, MongoDB, etc.

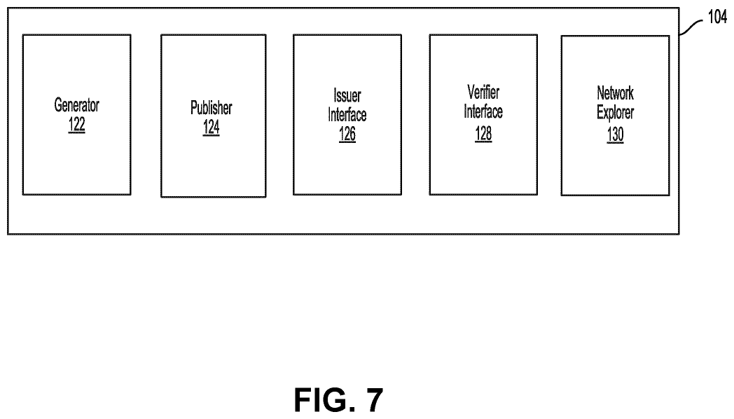

FIG. 7 is a high-level schematic of schema server 104, in accordance with an embodiment. As depicted, schema server 104 includes a generator 122, a publisher 124, an issuer interface 126, a verifier interface 128, and a network explorer 130.

Generator 122 generates schemas based on data received via issuer interface 126. A generated schema may be based on a pre-existing schema stored in electronic data store 120. A generated schema may be a modified version of such a pre-existing schema, with modifications defined by an issuer via issuer interface 126. A generated schema may include by reference one or more such pre-existing schema. Generator 122 also generates credential definitions based on one or more schemas.

Generator 122 may provide data defining one or more graphical user interfaces to be presented at an issuer device 10, the user interfaces including user interface elements facilitating entry of data for generating credential definitions or schemas.

Publisher 124 receives a credential definition generated at generator 122. In response to a publish request from an issuer received by way of issuer interface 126, publisher 124 transmits the generated schema to registry server 102 with an identifier of the requesting issuer, for inclusion in electronic data store 110. Such publication provides data at registry server 102 (e.g., within electronic data store 110) reflecting that the issuer issues digital credentials as defined by the published credential definition. In some embodiments, publisher 124 analyzes a credential definition for errors and completeness before transmitting it to registry server 102. In response to a publish request from an issuer, publisher 124 may also transmit a credential definition to a blockchain network (e.g., by way of a blockchain device 40) for inclusion in a blockchain.

Publisher 124 receives a schema generated at generator 122. In response to a publish request from an issuer received by way of issuer interface 126, publisher 124 transmits the generated schema to registry server 102 for inclusion in electronic database 120. Publisher 124 may also receive data reflective of schemas that are not generated by generator 122 (e.g., found by network explorer 130), and transmits the such schemas to registry server 102 for inclusion in electronic database 120. In some embodiments, publisher 124 analyzes a schema for errors and completeness before transmitting it to registry server 102. In response to a publish request from an issuer, publisher 124 may also transmit a schema to a blockchain network (e.g., by way of a blockchain device 40) for inclusion in the blockchain.

Issuer interface 126 provides an electronic interface for communication between schema server 104 and issuer devices 10. In some embodiments, the electronic interface may be a REST interface exposing an API for access by software executing at an issuer device 10.

Issuer interface 126 may receive a signal from an issuer device 10 reflecting a search of pre-existing schemas stored in electronic data store 120. Issuer interface 126 may transmit a signal to the issuer device 10 reflecting search results including one or more pre-existing schema. Such pre-existing schemas may be used by an issuer to generate a new schema. Accordingly, issuer interface 126 may also receive a signal from an issuer device 10 reflecting a selection of one or more schemas that a issuer wishes to use or modify in generating a new credential definition and/or new schema(s). Data for a generating a credential definition or schema(s) are sent generator 122 for processing. Issuer interface 126 may also receive a signal from an issuer device 10 reflecting a request from an issuer to publish a credential definition or a schema. Such requests are sent to publisher 124 for processing.

Verifier interface 128 provides an electronic interface for communication between schema server 104 and verifier devices 20. In some embodiments, the electronic interface may be a REST interface exposing an API for access by software executing at a verifier device 30.

Verifier interface 126 may receive a signal from a verifier device 30 reflecting searches for claims stored in electronic data store 110. Verifier interface 126 may transmit a signal reflecting search results to a verifier device 30. Verifier interface 126 may receive a signal from a verifier device 30 reflecting a selection of one or more credential definitions that the verifier will accept for verification. In other words, the verifier will accept the claims in a digital credential issued by a particular issuer using the selected credential definition. Verifier interface 126 may receive a signal from a verifier device 30 reflecting selection of one or more claims a verifier will accept for verification, e.g., when such claims are in a particular digital credential issued by a particular issuer. Such selections are transmitted to server 102 for inclusion in table 400 (FIG. 4).

Network explorer 130 explores one or more networks to locate data providing pre-existing schemas, issuers that issue particular schemas, and verifiers that accept particular claims or particular digital credentials. Located data are processed to be included in electronic data store 110 or electronic data store 120, as appropriate. Located data may be transmitted to registry server 102 in the form of a published schema. In some embodiments, network explorer 130 explores one or more blockchains. In some embodiments, network explorer 130 explores one or more websites.

### Example Operation

The operation of credentials registry system 100 is further described with reference to examples for an issuer, a verifier, and an end-user, respectively.

In a first example, an issuer is a government entity, namely, a Department of Motor Vehicles. This issuer seeks to issue digital credentials corresponding to a Driver's License. The issuer operates a given issuer device 10. To issue the desired digital credentials, the issuer generates a new credential definition using system 100.

During operation, schema server 104 receives, from the given issuer device 10 by way of issuer interface 124, a request to search existing schemas (e.g., in schemas stored in electronic data store 120) according to at least one search criterion. Schema server 104 conducts the requested search, e.g., by cooperation of registry searcher 114 at registry server 102. Schema server 104 transmits a response to the given issuer device 10, the response reflecting at least one matched schema of the plurality of schemas that satisfy the at least one search criterion. By operation of the given issuer device 10, the issuer selects one or more of the matched schemas to generate a new credential definition, e.g., using generator 122.

Schema server 104 receives, from the given issuer device 10 by way of issuer interface 124, data reflective of the new credential definition generated based on the at least one matched schema. The credential definition may include, for example, an identifier of the Department of Motor Vehicles.

Schema server 104 receives, from the given issuer device 10 by way of issuer interface 124, a publication request for the new credential definition and/or new schema(s) generated by the issuer. In response to the publication request, publisher 124 transmits a data record including data reflective of the new credential definition to registry server 102 for inclusion in electronic data store 110. In response to the publication request, publisher 124 may also transmit to registry server 102 a data record including data reflective of new schema(s) generated by the issuer in association with the new credential definition for inclusion in electronic data store 120. In response to a publication request, publisher 124 may transmit a data record including data reflective of the new credential definition and/or new schema(s) to a blockchain network. The new credential definition may be published in association with an identifier of the issuer, which may be a decentralized identifier.

Once the new credential definition has been published, the issuer can begin issuing digital credentials as defined by the new credential definition.

Once the new credential definition has been published, a verifier can indicate that it accepts one or more claims of a digital credential issued based on the credential definition. A verifier can provide such an indication by transmitting a signal from a verifier device 30 to registry server 102 via verifier interface 116. The signal encodes data reflecting an identifier of the verifier (which may be a decentralized identifier) and indicators of one or more claims that it accepts.

In a second example, a verifier is a car rental company that seeks to verify certain attributes of a subject entity (e.g., an individual, a company, or the like). The verifier operates a given verifier device 30. To begin, the verifier generates a proof request. The proof request is a data structure that defines the set of one or more attributes of the entity that the verifier seeks to verify (e.g., a name, address, or the like).

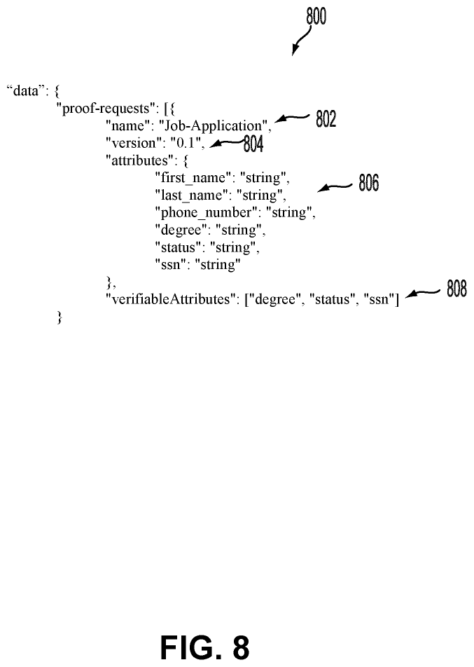

An example proof request 800 is shown in FIG. 8. As shown, proof request 800 includes a name 802, a version 804, a list of attributes 806, and a list of verifiable attributes 808 that the verifier seeks to verify. Not all attributes in a proof request are to be verified; as such, attributes 806 may be a superset of verifiable attributes 808. Attributes 806 that are not verifiable attributes may be provided in proof request as supporting metadata. Such metadata may, for example, facilitate identification of a relevant digital credential.

During operation, registry server 102 receives, from a given verifier device 30, a proof request which includes at least one attribute about an entity that the verifier seeks to verify. Registry searcher 114 at registry server 102 searches within electronic data store 110 to identify credential definitions that include a claim that matches an attribute of the proof request. Registry server 102 transmits a response to the given verifier device 30, the response including a list of the matching credential definitions. In some embodiments, the response may include trust scores of the claims in the matching credential definitions. In some embodiments, a user interface is provided at verifier device 30 which allows a verifier to sort and/or filter the matching credentials definitions based on trust scores of the claims in credentials definitions.

In a third example, an end-user obtains information regarding digital credentials from registry server 102. The end-user operates a given end-user device 20.

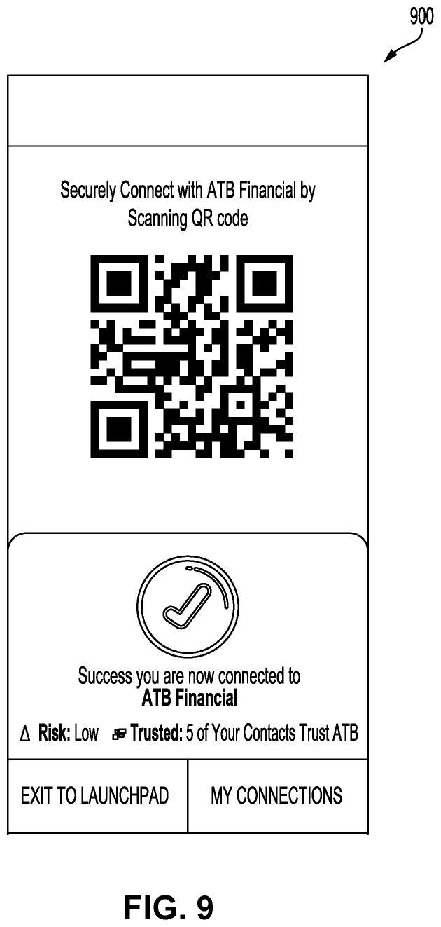

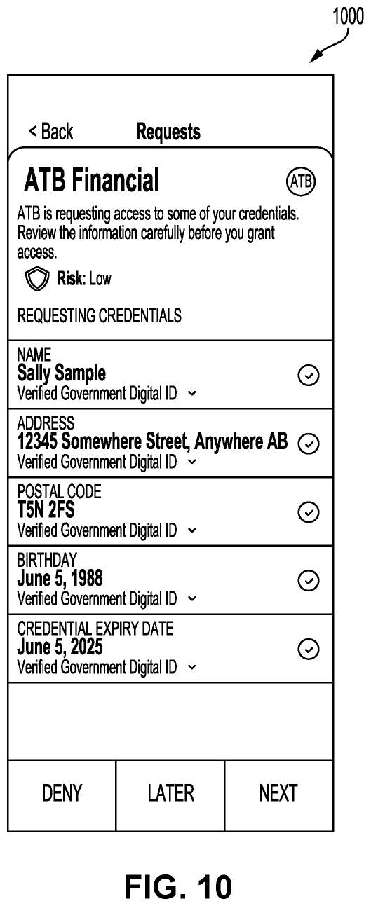

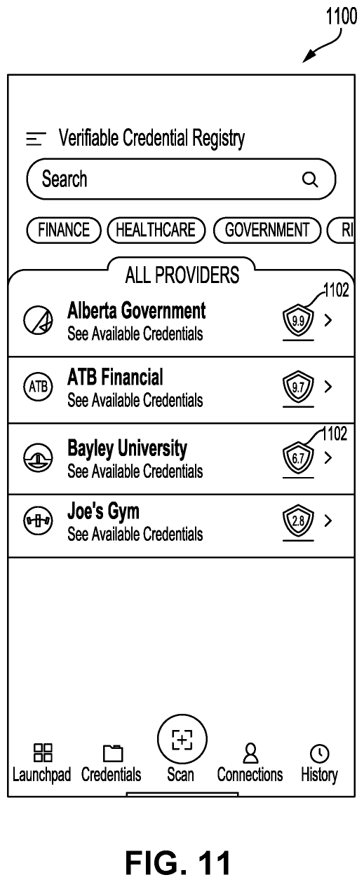

FIG. 9 is an example screen 900 of a wallet application executing at the given end-user device 20, in accordance with an embodiment. As shown, the wallet application allows end-users to connect to other users, issuers, and verifiers. In some embodiments, the manner of connection may be similar to that of a social network. Data defining social network nodes and links may be stored, for example, at system 100.

Screen 900 shows a end-user making a connection to a particular verifier, e.g., after the end-user has accepted an invitation to connect from the verifier. Screen 900 provides an indication of the trustworthiness of the verifier and a level of risk for the connection. As shown, the verifier may transmit data defining a QR code for display by an end-user, the QR code reflecting an invitation to connect. The QR code may encode a public key of the The end-user may scan the QR code at an end-user device 20 to accept the invitation. A similar user interface may be provided at the wallet application to allow an end-user to make a connection to a particular issuer.

FIG. 10 is an example screen 1000 of a wallet application executing at the given end-user device 20, in accordance with an embodiment. The wallet application may store various digital credentials issued to the end-user operating the given end-user device 20, with each digital credential containing one or more claims about the attributes of the end-user. As shown, the wallet application allows end-users to control which claims to present to a particular verifier upon request by the verifier. Screen 900 shows an example of a verifier seeking to obtain the end-user's name, address, postal code, birthday, and credential expiry date. If the end-user permits the verifier to obtain these claims, the verifier can perform verification of the claims in manners disclosed herein.

During operation, the end-user can also use the wallet application to search for various data at registry server 102. For example, registry server 102 receives, by way of end-user interface 118 from a given end-user device 20, a request to search within electronic data store 110 based on at least one search criterion. A search is conducted by registry searcher 114 to identify credential definitions that satisfy the at least one search criterion. A response is transmitted, by way of end-user interface 118 to the given end-user device 20, where the response includes a list of the matching credential definitions. The response may include identifiers of the issuers (which may be decentralized identifiers) allowing the end-user to pro-actively connect with the issuer and request a digital credential.

FIG. 11 an example screen 1100 of a wallet application executing at the given end-user device 20, in accordance with an embodiment. Screen 1100 shows a list of issuers responsive to the request made by the end-user. Also shown, the end-user may click on (or otherwise activate) a particular issuer to see digital credentials (and constituent claims) that are issued by that issuer. Each issuer is shown with an indication of trust scores of claims issued by the issuer and/or an aggregate trust score 1102 for the issuer.

In some embodiments, the wallet application allows the end-user to search registry server 102 for particular verifiers, e.g., to search for verifiers that accept claims in digital credentials stored in the user's wallet. Registry server 102 may provide the end-user with identifiers of the verifiers (which may be decentralized identifiers) allowing the end-user to pro-actively connect with the verifier and request acceptance of a claim, e.g., to obtain access to products or services of the verifier.

In some embodiments, the wallet application allows the end-user to search registry server 102 for issuers that issue claims having a particular trust score, e.g., meeting a minimum trust score. In some embodiments, the wallet application allows search results to be sorted or filtered by a trust score.

Other Aspects

In some embodiments, a claim may relate to a heath attribute of an individual, such as for example, an immunization history, medications taken or required, history of medical procedures, allergies, or the like.

In some embodiments, a claim may relate to an individual's assets such as assets that are owned, leased, rented, or possessed by the individual, assets

In some embodiments, a claim may relate to an individual's employment information such as current employment status, current employer, employment history, professional accreditations, professional licenses, or the like.

In some embodiments, a claim may relate to an individual's educational information such as degrees or certifications obtained, institutions attended and when, courses attended, grades received for particular courses, grade point averages, or the like.

In the embodiments described above, digital credentials include claims that relate to attributes of an individual. However, in some embodiments, digital credentials may include claims that relate to attributes of an organization (e.g., a company, corporation, association, etc.). Such claims may, for example, relate to organization's finances such as financial statements, audits, or the like. Such claims may, for example, relate to an organization's formation documents such as Articles of Incorporation, by-laws, or the like. Such claims may, for example, relate to an organization's capitalization structure such as a list of shareholders and/or shareholdings, or the like. Such claims may, for example, relate to an organization's licenses such as government permits, export/import permits, or the like.

Each of registry updater 112, registry server 114, verifier interface 116, end-user interface 118, generator 122, publisher 124, issuer interface 106, verifier interface 128, and network explorer 130 may be implemented using conventional programming languages such as Java, J #, C, C++, C #, Perl, Visual Basic, Ruby, Scala, etc. These components of system 100 may be in the form of one or more executable programs, scripts, routines, statically/dynamically linkable libraries, or the like.

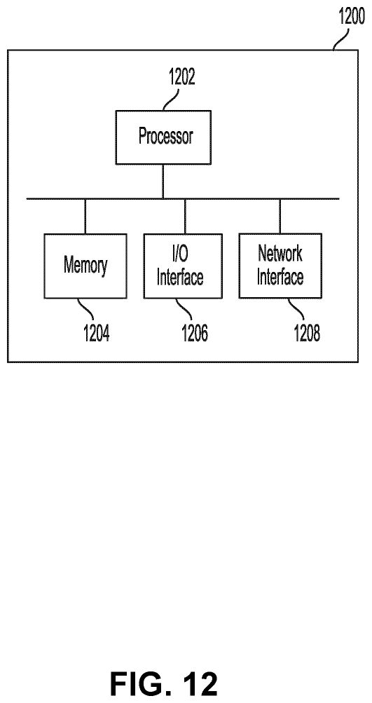

FIG. 12 is a schematic diagram of computing device 1200 which may be used to implement one or both of registry server 102 and schema server 104, in accordance with an embodiment.

As depicted, computing device 1200 includes at least one processor 1202, memory 1204, at least one I/O interface 1206, and at least one network interface 1208.

Each processor 1202 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1204 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1200 is shown but system 100 may include multiple computing devices 1200. The computing devices 1200 may be the same or different types of devices. The computing devices 1200 may be connected in various ways including directly coupled, indirectly coupled via a network, and distributed over a wide geographic area and connected via a network (which may be referred to as “cloud computing”).

For example, and without limitation, a computing device 1200 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

In some embodiments, a computing device 1200 may function as an issuer device 10, an end-user device 20, a verifier device 30, and/or a blockchain device 40.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented method for providing a digital credentials registry, the method comprising:
receiving, from an issuer device, a request to search an electronic data store storing data records reflective of a plurality of schemas for defining credential definitions, the request including at least one search criterion;
transmitting a response to the issuer device reflecting at least one matched schema of the plurality of schemas, the matched schema satisfying the at least one search criterion; and
receiving, from the issuer device, data reflective of a credential definition based on at least one of the matched schema, the credential definition including a plurality of claims available to be made by the issuer about another entity.

2. The computer-implemented method of claim 1, further comprising:
generating a credential definition data record including data reflective of the credential definition defined by the issuer and a decentralized identifier of the issuer.

3. The computer-implemented method of claim 2, further comprising:
transmitting the credential definition data record to a blockchain network.

4. The computer-implemented method of claim 2, further comprising:
maintaining the credential definition data record in an electronic data store of the digital credentials registry.

5. The computer-implemented method of claim 2, wherein the credential definition data record includes data reflective of a plurality of trust scores, each reflective of a degree of trustworthiness of a corresponding claim in the credential definition.

6. The computer-implemented method of claim 1, further comprising:
generating a schema data record reflective of a schema defining the credential definition defined by the issuer, the schema differing from the plurality of schemas.

7. The computer-implemented method of claim 6, further comprising:
transmitting the schema data record to a blockchain network.

8. The computer-implemented method of claim 6, further comprising:
maintaining the schema data record in an electronic data store of the digital credentials registry.

9. The computer-implemented method of claim 1, wherein the credential definition is based on at least two of the plurality of schemas.

10. A computer-implemented system for providing a digital credentials registry, the system comprising:
at least one processor;
memory in communication with the at least one processor, and
software code stored in the memory, which when executed by the at least one processor causes the system to:
receive, from an issuer device, a request to search an electronic data store storing data record reflective of a plurality of schemas for defining credential definitions, the request including at least one search criterion;
transmit a response to the issuer device reflecting at least one matched schema of the plurality of schemas, the matched schema satisfying the at least one search criterion; and
receive, from the issuer device, data reflective of a credential definition based on at least one of the matched schema, the credential definition including a plurality of claims available to be made by the issuer about another entity.

11. A computer-implemented method for providing a digital credentials registry, the method comprising:
receiving, from a verifier device, a proof request, the proof request including at least one attribute about an entity;
searching within an electronic data store storing data records of a plurality of credential definitions to identifying those matching credential definitions that include a claim that matches an attribute of the proof request; and
transmitting a response to the verifier device that includes a list of the matching credential definitions.

12. The computer-implemented method of claim 11, where the response includes, for each of the matching credential definitions, a corresponding decentralized identifier of a particular issuer for that matching credential definition.

13. The computer-implemented method of claim 11, where the response includes, for each claim of each of the matching credential definitions, a corresponding trust score reflective of a degree of trustworthiness of that claim.

14. A computer-implemented system for providing a digital credentials registry, the system comprising:
at least one processor;
memory in communication with the at least one processor, and
software code stored in the memory, which when executed by the at least one processor causes the system to:
receive, from a verifier device, a proof request, the proof request including at least one attribute about an entity;
search within an electronic data store storing data records of a plurality of credential definitions to identifying those matching credential definitions that include a claim that matches an attribute of the proof request; and
transmit a response to the verifier device that includes a list of the matching credential definitions.

15. (canceled)

16. (canceled)

17. (canceled)

18. (canceled)

19. (canceled)

20. (canceled)

21. The computer-implemented system of claim 10, wherein the software code when executed by the at least one processor causes the system to:
generate a credential definition data record including data reflective of the credential definition defined by the issuer and a decentralized identifier of the issuer.

22. The computer-implemented system of claim 21, wherein the software code when executed by the at least one processor causes the system to:
transmit the credential definition data record to a blockchain network.

23. The computer-implemented system of claim 21, wherein the software code when executed by the at least one processor causes the system to:
maintain the credential definition data record in an electronic data store of the digital credentials registry.

24. The computer-implemented system of claim 21, wherein the credential definition data record includes data reflective of a plurality of trust scores, each reflective of a degree of trustworthiness of a corresponding claim in the credential definition.

25. The computer-implemented system of claim 10, wherein the credential definition is based on at least two of the plurality of schemas.
